(19) United States
(12) Patent Application Publication
(10) Pub. No.: US 2017/0005387 A1
(43) Pub. Date: Jan. 5, 2017

(54) PHASE SHIFTER WITH ASYMMETRIC DIELECTRIC UNIT

(71) Applicants: Yu-Chia HSU, Taichung City (TW); Kai-Hao CHEN, Changhua County (TW)

(72) Inventors: Yu-Chia HSU, Taichung City (TW); Kai-Hao CHEN, Changhua County (TW)

(73) Assignee: WHA YU INDUSTRIAL CO., LTD., Hsinchu City (TW)

(21) Appl. No.: 14/789,052

(22) Filed: Jul. 1, 2015

(51) Int. Cl. H01P 1/18

(52) U.S. Cl. CPC H01P 1/184

(57) ABSTRACT

A phase shifter with asymmetric dielectric unit includes: a feed layer, with circuit layout surface and back side; a stripline feeding network fixed to the circuit layout surface, including a phase shifting unit and a power distribution unit; an asymmetric dielectric unit, including the upper dielectric plate on the circuit layout surface of corresponding feed layer and a lower dielectric plate on the back side of corresponding feed layer, the upper and lower dielectric plates are pairwise located and shift simultaneously, corresponding to the fixed transmission line section of phase shifting unit, the phase is changed by shifting the dielectric plates for phase shift function; the ends corresponding to the displacement direction of the dielectric plates are asymmetrically laid by staggering the edge positions; and an interlocking frame, located in the circuit layout surface and back side of feed layer, for driving the upper and lower dielectric plates to shift.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a phase shifter, and more particularly to an innovative phase shifter structure type disclosure integrated with stripline feeding network and asymmetric dielectric unit.

2. Description of Related Art Including Information Disclosed Under 37 CFR 1.97 and 37 CFR 1.98.

The phase shifter is a device which adjusts the phase of an electric wave, and it moves the phase of signal for an angle. However, the actuation mode of the phase shifter varies with the product structure type.

The phase shifter is integrated into array antenna product structures extensively, and different radiators in an antenna can feed in signals of different phases by the adjustment of the phase shifter, so as to radiate beams in different directions in space.

A prior art type of phase shifter is shown in FIG. 1. Paired spaced phase shifter subunits 06 are mounted on the external surface of a metallic reflecting plate 05. Said phase shifter subunit 06 is usually a three-dimensional salient mechanical scalable adjusting mechanism. A power divider 07 made of a circuit board is independently mounted on the external surface of the metallic reflecting plate 05. Said power divider 07 and phase shifter subunits 06 are connected by multiple conducting wires 08 to reach the preset electrical transport state.

However, the prior art phase shifter structure still has the following problems: as the feeding network complexity of the known phase shifter is too high, there are too many and scattered components of stripline components, phase shifter subunits and power dividers, so that the difficulty in the assembly of the phase shifter is increased, the assembly yield of wires and components decreases relatively (note: poor stripline soldering is likely to degrade characteristics and result in high difficulty in debugging), and the manufacturing cost is increased.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “phase shifter with asymmetric dielectric unit” disclosed by the present invention is an innovative unique structure type and has the technical characteristic of being formed of said feed layer, the stripline feeding network with phase shifting unit and power distribution unit, upper and lower dielectric plates with asymmetric end edges, interlocking frame and metal layer, compared with the known structure proposed by previous technologies, as the stripline feeding network integrates the phase shifting unit and power distribution unit into the same stripline structure, many cable conductor layout and welding procedures can be reduced compared with the known structure, so as to simplify the structure type of phase shifter feeding network greatly, the stripline welding positions can be reduced greatly, the phase shifting unit and power distribution unit can be integrated into the same stripline feeding network structure, so that the overall phase shifter has practical advancement and better industrial economy, such as easier assembly, higher assembly yield and lower manufacturing cost.

On the other hand, due to the technical characteristic of asymmetric layout of the end edges of the upper and lower dielectric plates, the present invention has more accurate phase shift adjustment effect, implementing more ideal and practical phase shift function to meet the client-side multiple demands for antenna products.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a plan view of a known phase shifter.

FIG. 2 is a combined stereogram of the preferred embodiment of the present invention.

FIG. 3 is an exploded view of the preferred embodiment of the present invention.

FIG. 4 is a three-dimensional enlarged view I of the local structure of the present invention.

FIG. 5 is a three-dimensional enlarged view II of the local structure of the present invention.

FIG. 6 is a section plan I of the local structure of the present invention.

FIG. 7 is a section plan II of the local structure of the present invention.

FIG. 8 is a three-dimensional diagram I of the asymmetric layout of the upper and lower dielectric plate ends of the present invention (note: feed layer is omitted from this figure of purpose).

FIG. 9 is a three-dimensional diagram II of the asymmetric layout of the upper and lower dielectric plate ends of the present invention (note: feed layer is omitted from this figure of purpose).

FIG. 10 is an actuation state diagram I of the asymmetric dielectric unit of the present invention.

FIG. 11 is an actuation state diagram II of the asymmetric dielectric unit of the present invention.

FIG. 12 is a schematic plan I of the actuation state of the interlocking frame of the present invention.

FIG. 13 is a schematic plan II of the actuation state of the interlocking frame of the present invention.

FIG. 14 is a comparison curve diagram of the phase shift adjustment effect of the asymmetric dielectric unit of the present invention and the phase shift adjustment effect of the known symmetric dielectric unit.

FIG. 15 is an embodiment of support between the upper and lower dielectric plates of the present invention.

### DETAILED DESCRIPTION OF THE INVENTION

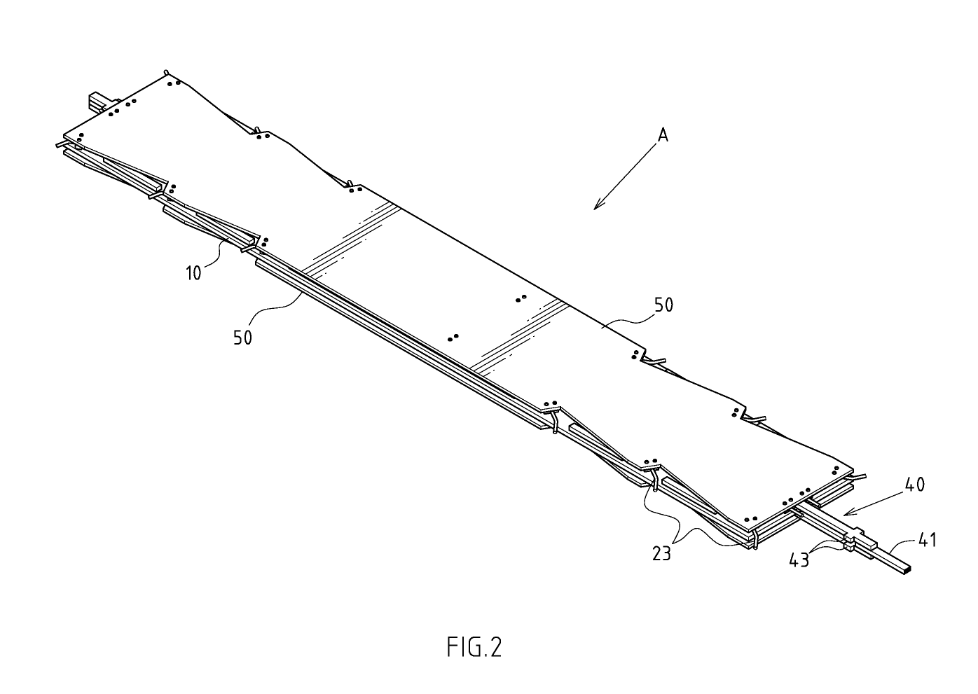

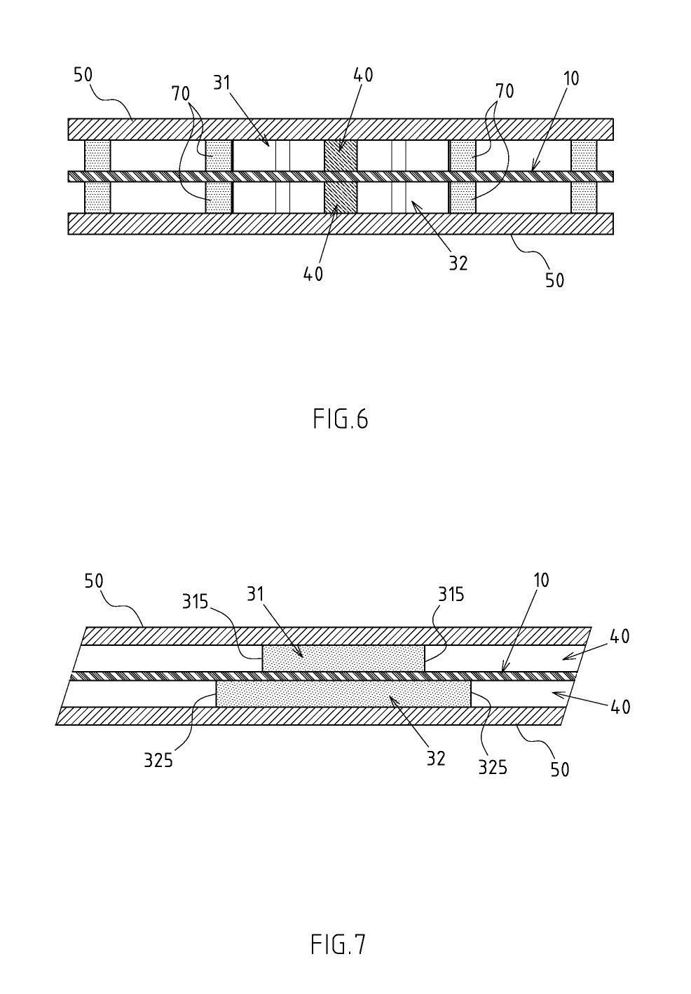

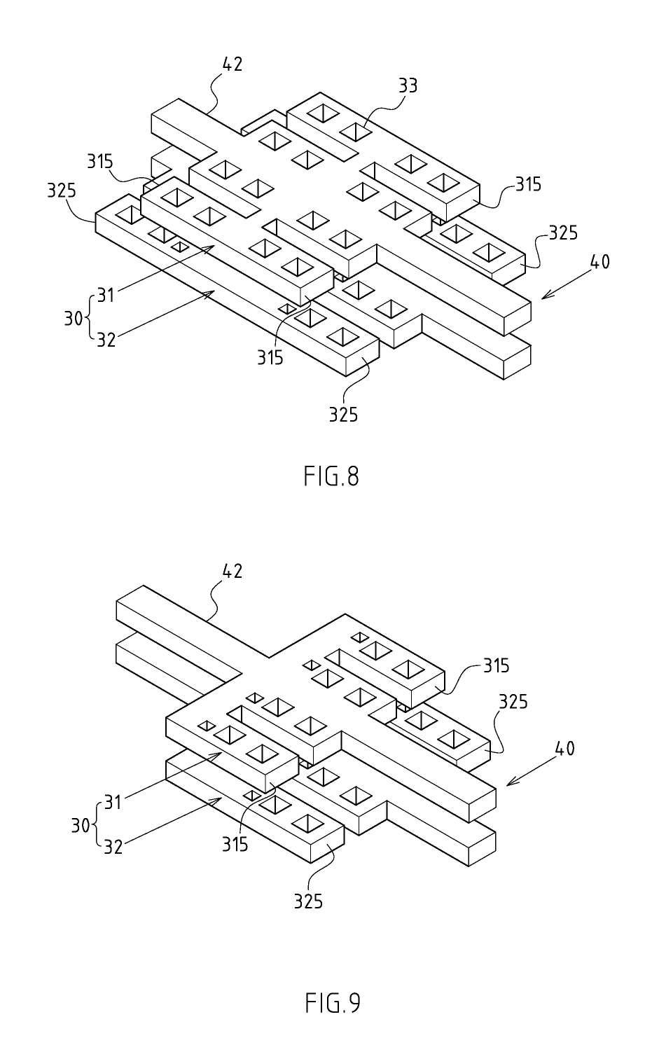

Referring to FIGS. 2 to 9, the preferred embodiment of this phase shifter with asymmetric dielectric unit in accordance with the present invention is shown. However, this embodiment is for illustration purposes only. Said phase shifter A comprises a feed layer 10, formed of insulator, with a circuit layout surface 11 and a back side 12. A stripline feeding network 20 is provided as a as strip conductor fixed to the circuit layout surface 11 of feed layer 10. The stripline feeding network 20 includes at least one phase shifting unit 21, formed of spaced two fixed transmission line sections 213 and an inflection section 215 between the ends of the two fixed transmission line sections 213. At least one power distribution unit 22 is forked and electrically connected to phase shifting unit 21, and one fork end of the power distribution unit 22 is electrically connected to a feed line 23. The phase shifter A has an asymmetric dielectric unit 30, including the upper dielectric plate 31 located in the circuit layout surface 11 of corresponding feed layer 10 and the lower dielectric plate 32 located in the back side of corresponding feed layer 10, the upper dielectric plate 31 and lower dielectric plate 32 are located pairwise and actuated simultaneously, corresponding to the fixed transmission line section 213 of phase shifting unit 21, so as to change the phase by shift control of the upper dielectric plate 31 and lower dielectric plate 32 for phase shift function. The ends 315, 325 corresponding to the displacement direction of the upper dielectric plate 31 and lower dielectric plate 32 are laid asymmetrically by staggering the edges (as shown in FIGS. 7 and 8). At least one interlocking frame 40 is located in circuit layout surface 11 and back side 12 of feed layer 10 in displacement actuation state. The interlocking frame 40 has a driven end 41 and an interlocking section 42, the interlocking section 42 is for locating the upper dielectric plate 31 and lower dielectric plate 32 of asymmetric dielectric unit 30, the interlocking frame 40 drives the upper dielectric plate 31 and lower dielectric plate 32 to shift. At least one metal layer 50 is located in corresponding gap of at least one side of feed layer 10.

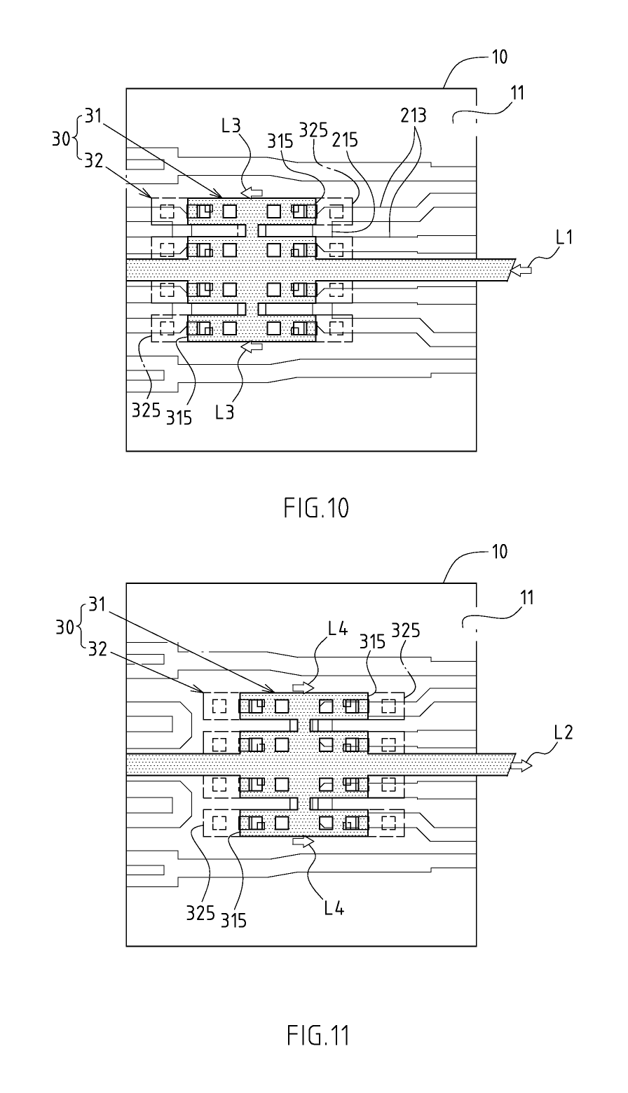

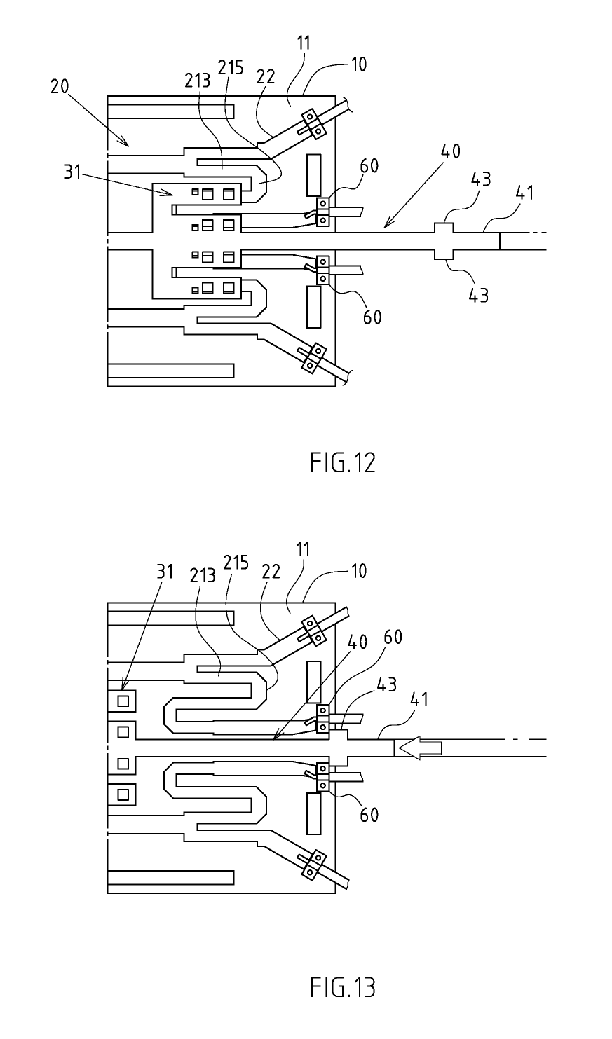

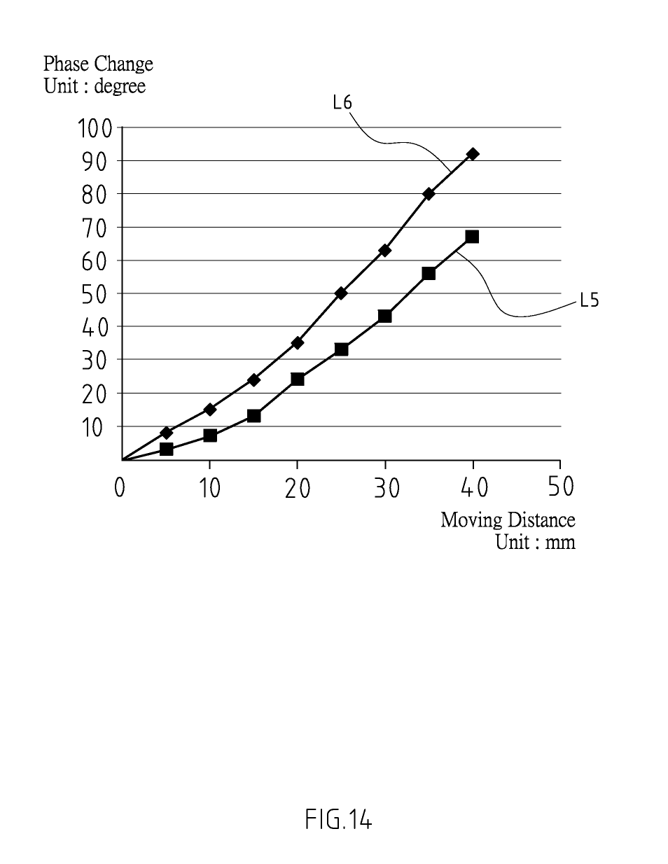

According to said structural composition design, the phase shift system and actuation of phase shifter A disclosed by the present invention are shown in FIGS. 10 and 11. The push-and-pull action of interlocking frame 40 (see Arrow L1 in FIG. 10 and Arrow L2 in FIG. 11) drives the synchronous forward-backward displacement of upper dielectric plate 31 and lower dielectric plate 32 of asymmetric dielectric unit 30 (see Arrow L3 in FIG. 10 and Arrow L4 in FIG. 11). In this actuation process, as the relative positions of said upper dielectric plate 31 and lower dielectric plate 32 and the fixed transmission line section 213 of phase shifting unit 21 change, with the displacement of the upper and lower dielectric plates 31, 32, the phase is changed to implement the function of phase shift control (the larger the coverage area is, the longer is the overlap length, the larger is the phase shift amount). Due to the technical characteristic of asymmetric layout of ends 315, 325 of the upper dielectric plate 31 and lower dielectric plate 32 with edges staggered, compared with the existing general type of aligned edges, as shown in FIG. 14, in the same displacement condition, the asymmetric type of the present invention (see Curve L5) has more a accurate phase shift adjustment effect than the known symmetric type (see Curve L6), so as to implement more ideal and practical phase shift function to meet the client-side multiple demands for antenna products.

As shown in FIG. 5, a fixed block 60 can be mounted on the circuit layout surface 11 of the feed layer 10, said fixed block 60 has a feed line welding caulking groove 61 and a metal layer locking hole 62 (bolt hole or punch hole), and the interlocking frame 40 has a flange 43 which stops at the fixed block 60 when the interlocking frame 40 shifts to the set distance (see the actuation variation in FIGS. 10 and 11), so as to limit the displacement state of interlocking frame 40, therefore, the fixed block 60 shall be the welding interface of grounding part of feed line 23, the space fixing part between feed layer 10 and metal layer 50 and the limiting structure of interlocking frame 40 simultaneously.

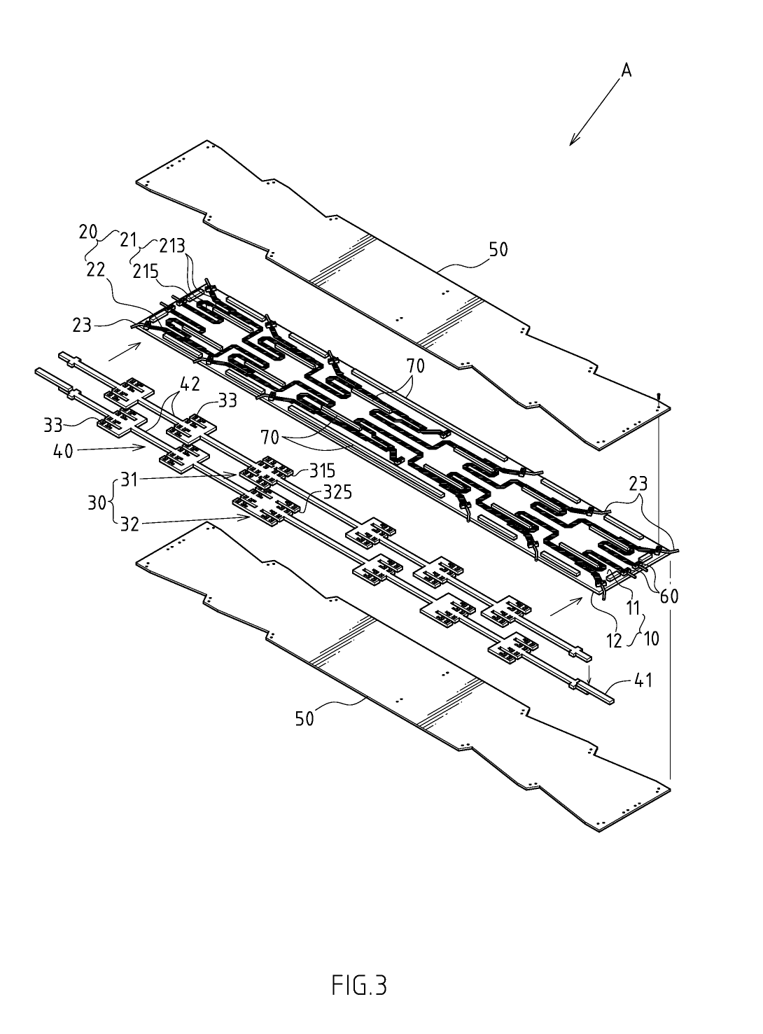

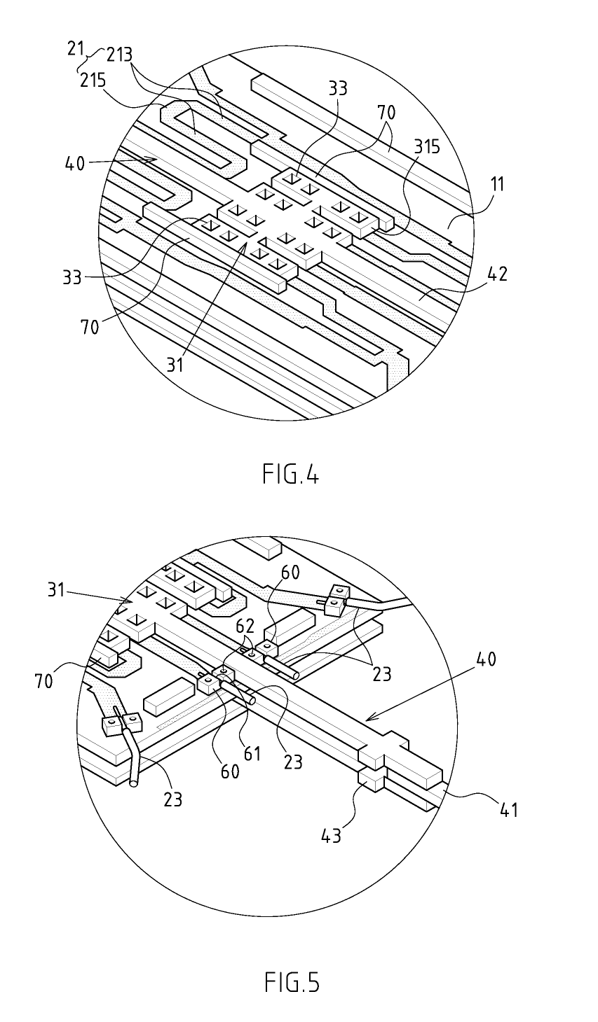

As shown in FIGS. 3 and 4, a support stop bar 70 can be mounted corresponding the upper and lower dielectric plates 31, 32 on the feed layer 10 surface to prevent lateral deviation when the upper and lower dielectric plates 31, 32 are actuated, and it supports the activity space height of dielectric plates. Said support stop bar 70 in this case can be implemented by foam, plastic or other materials.

As shown in FIGS. 3 and 4, there can be a punch hole 33 (or groove) in the upper dielectric plate 31 and lower dielectric plate 32, the size, shape, registration or dislocation of punch hole 33 (or groove) in the upper dielectric plate 31 and lower dielectric plate 32 can be changed to obtain different phase shift effects.

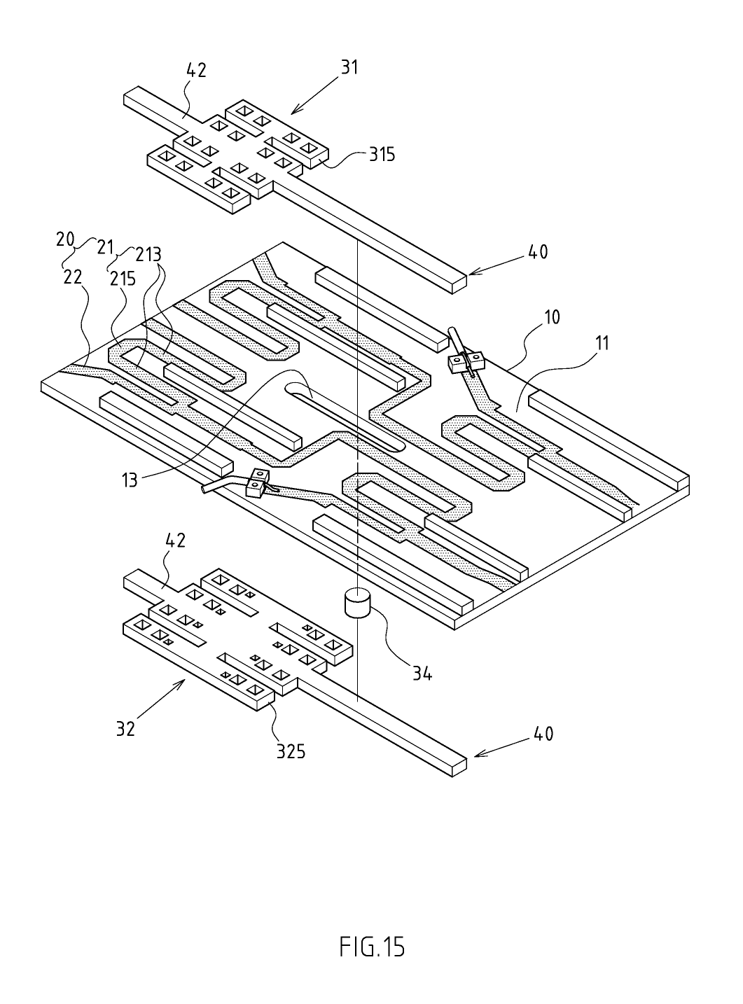

As shown in FIG. 15, there can be a long through hole 13 in the feed layer 10, and the upper dielectric plate 31 and lower dielectric plate 32 are connected by a support 34, the long through hole 13 lets the support 34 pass through, and provides the limiting guide when the support 34 is actuated.

As shown in FIG. 3, the upper dielectric plate 31 and lower dielectric plate 32 can be multiple arrays laid in the trend of interlocking section 42 of interlocking frame 40, corresponding to the type of phase shifting unit 21 position. This layout type is a preferred embodiment, but the present invention should not be limited to this.

The stripline feeding network 20 can be formed of sheet metal fixed to the circuit layout surface 11 of feed layer 10, or the feed layer 10 is printed circuit board, the stripline feeding network 20 is formed by etching.

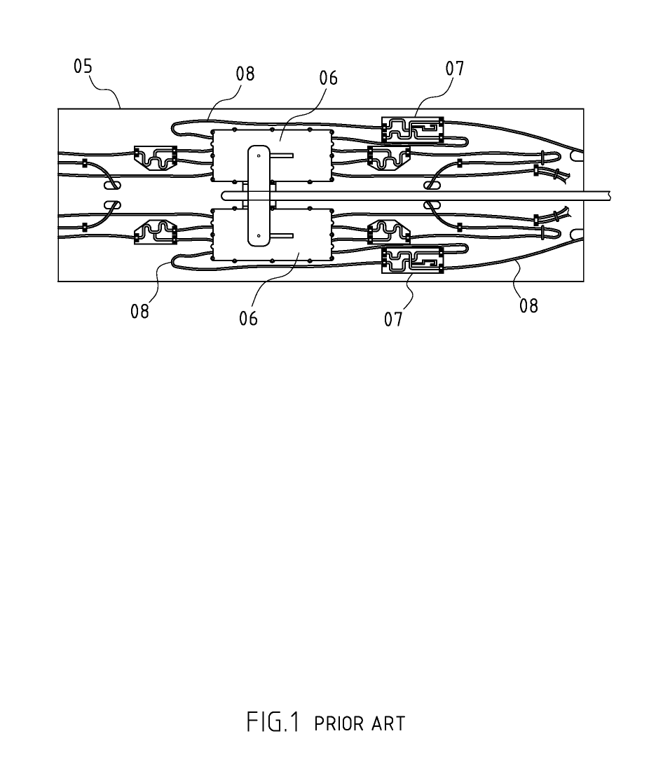

As shown in FIGS. 1 and 2, there can be two pieces of metal layer 50 located in the corresponding position of back side of feed layer 10 and in the corresponding position of circuit layout surface respectively.

In specific implementation of the upper dielectric plate 31, lower dielectric plate 32 and interlocking frame 40, they can be formed by cutting an acrylic sheet (high dielectric material), but the present invention should not be limited to this.

In addition, not all of the interlocking section 42 of interlocking frame 40 corresponding to the fixed transmission line section 213 of phase shifting unit 21 are provided with said asymmetric dielectric unit 30, it can be provided with general symmetric dielectric unit, this part is as the interlocking section 42 of interlocking frame 40 in FIG. 3. There are multiple dielectric units, but there is only locally an asymmetric dielectric unit 30, the other dielectric units are of symmetric dielectric unit type; namely, the number of asymmetric dielectric unit 30 can be determined according to the phase shift function needed by the industry as single-unit or multi-unit layout type.

As shown in FIGS. 7 and 8, said asymmetrically laid upper dielectric plate 31 and lower dielectric plate 32 with ends 315, 325 can be merged and laid back to back. The difference of this embodiment can be clarified as compared with the general implementation in FIG. 9.

We claim:

1. A phase shifter with asymmetric dielectric unit, including:
a feed layer, formed of insulator, with a circuit layout surface and a back side;
a stripline feeding network, as strip conductor fixed to the circuit layout surface of feed layer, the stripline feeding network has:
at least a phase shifting unit, formed of spaced two fixed transmission line sections and an inflection section between the ends of two fixed transmission line sections;
at least one power distribution unit, forked and electrically connected to the phase shifting unit, one fork end of the power distribution unit is electrically connected to a feed line;
asymmetric dielectric unit, including the upper dielectric plate on the circuit layout surface of corresponding feed layer and the lower dielectric plate on the back side of corresponding feed layer, the upper dielectric plate and lower dielectric plate are pairwise located and actuated simultaneously, corresponding to the fixed transmission line section of phase shifting unit, the phase is changed by shifting the upper dielectric plate and lower dielectric plate to implement phase shift function;
the ends corresponding to the displacement direction of the upper dielectric plate and lower dielectric plate are asymmetrically laid by staggering the edge positions;
at least an interlocking frame, located in circuit layout surface and back side of feed layer in displacement actuation state, the interlocking frame has a driven end and an interlocking section; the interlocking section is for locating the upper dielectric plate and lower dielectric plate of asymmetric dielectric unit, the interlocking frame drives the upper dielectric plate and lower dielectric plate to shift;
at least one metal layer, located in the corresponding gap of at least one side of feed layer.

2. The structure defined in claim 1, wherein the circuit layout surface of the feed layer has a fixed block, said fixed block has a feed line welding caulking groove and metal layer locking hole, the interlocking frame has a flange which stops at the fixed block when the interlocking frame shifts to the preset distance, so as to limit the displacement state of interlocking frame, the fixed block shall be the welding interface of grounding part of feed line, the spacing fixing part for feed layer and metal layer and the limiting structure of interlocking frame simultaneously.

3. The structure defined in claim 2, wherein there is a support stop bar corresponding to the upper and lower dielectric plates on the feed layer surface, for preventing lateral deviation when the upper and lower dielectric plates are actuated, and supporting the activity space height for the upper and lower dielectric plates.

4. The structure defined in claim 3, wherein there are punch holes or grooves in the upper dielectric plate and lower dielectric plate, the size, shape, registration or dislocation of the punch holes or grooves in the upper dielectric plate and lower dielectric plate is changed for different phase shift effects.

5. The structure defined in claim 4, wherein the feed layer has a long through hole, and the upper dielectric plate and lower dielectric plate are connected by a support, the long through hole lets the support pass through, and provides limit guide when the support shifts.

6. The structure defined in claim 5, wherein multiple upper dielectric plates and lower dielectric plates are laid along the trend of interlocking section of interlocking frame, corresponding to the phase shifting unit position.

7. The structure defined in claim 6, wherein the stripline feeding network is formed of sheet metal fixed to the circuit layout surface of feed layer; or the feed layer is printed circuit board, the stripline feeding network is formed by etching.

8. The structure defined in claim 7, wherein two pieces of said metal layer are located in the corresponding position of back side of feed layer and in the corresponding position of circuit layout surface respectively.
